(19) United States
(12) Patent Application Publication
(10) Pub. No.: US 2005/0123110 A1
(43) Pub. Date: Jun. 9, 2005

(54) Pre-pay conference call service

(76) Inventor: Phil Wilkinson, Kittery, ME (US)

Correspondence Address: Edward A. Pennington, Esq.;Swidler Berlin Shereff Friedman, LLP, Suite 300, 3000 K Street, N.W., Washington, DC, 20007-5116, US

(21) Appl. No.: 10/727,520

(22) Filed: Dec. 5, 2003

(51) Int. Cl. H04M 15/00; H04M 3/42

(52) U.S. Cl. 379/114.2; 379/202.01

(57) ABSTRACT

A conference call is established upon dialing an access number and providing a valid pin number, whereby an owner can dynamically add additional parties to the conference call. Additional parties are added to the conference call by the owner entering a code and dialing a destination number. The owner of the conference can return to a conference call when there is no connection with the destination number by entering a reject code. The owner of the conference can return to a conference with a dialed party when there is a connection with the destination number by entering an accept code.

### BACKGROUND OF THE INVENTION

1. Field of the Invention

The present invention relates to a method, a system and computer program product for enabling pre-pay conference calling. More particularly, the present invention relates to a method, a system and a computer program product for an interface enabling pre-paid conferencing between multiple parties.

2. Description of the Prior Art

Generally, teleconferencing services are used to provide call conferencing between parties. Typically, these teleconferencing services are subscription based services. A subscriber to a teleconferencing service is provided with an access number and a passcode. The passcode can be an identifier that uniquely identifies a subscriber, such as a pin number. In some cases, the subscriber is required to reserve a time for when a conference call will be performed. Upon reserving a time for the conference call, the number of parties that are to participate in the conference call is also specified. The party coordinating the conference call, such as a moderator and owner, provides each party to the conference call with the access number and passcode. At the time designated for the conference call, each party dials the access number and enters the passcode when prompted.

These type of teleconferencing services pose several problems. Often the parties schedule to participate in the conference call become unavailable at the designated time. As a result, the conference call must be reschedule in hopes that at the re-scheduled time all the parties will be available to participate in the re-conference call.

An additional drawback to these type of systems is that the number of parties to the conference call is static. Because each party to the conference call has to access the system themselves, the party scheduling the conference call cannot include additional parties dynamically based on needs that arise during the conference call. This requires that another conference call is scheduled to include these additional parties. Alternatively, someone must exit the conference call, attempt to contact the additional parties, provide the additional parties with the access number and passcode, rejoin the conference call, then wait for the additional parties to join to conference call already in progress. As you can see this process is quite tedious and time intensive, resulting in a substantial amount of unproductivity during the conference call.

Another problem with these type of teleconferencing systems is that access numbers and passcodes must be disseminated to the parties in advance. For security purposes passcodes must be changed occasionally to prevent fraudulent use of the subscriber's teleconferencing account by a party privy to the passcode. This also is a tedious task which takes up a considerable amount of time.

Other teleconferencing services allow subscribers to perform conference calls without having prior reservations. However, these type of teleconferencing services also suffer from the similar problems as reservation based teleconferencing services discussed above.

Thus, there is a need for a method of providing teleconferencing services. There is also a need for the method to provide teleconferencing services on a pre-paid basis. There is also a need for the method to provide teleconferencing between multiple participants. There is also a need for the method to provide teleconferencing between multiple parties under the direction of a touch tone interface. There is also a need for the method to provide teleconferencing services where the charges are based on legs of communication between parties.

### SUMMARY OF THE INVENTION

According to embodiments of the present invention, a method, a framework, and a computer program product for providing pre-paid conference calls are provided. The method receives access number data and pin number data. Upon receiving a valid pin number the method establishes a conference call whereby an owner can dynamically add additional parties to the conference call. The method receives a destination number from the owner and determines whether there is a call connection established with a device at the destination number. If there is an answer at the destination number the owner and the party at the destination number are made part of the conference call. If there is no answer at the destination number the owner can enter a reject code that returns the owner to the conference call. This process can be repeated iteratively for a number of destination numbers.

In an embodiment of the present invention, the method of providing pre-paid multi-party conference services includes initiating a conference call, receiving a first destination number from a first device, receiving a first code from the first device specifying whether to include the destination number to the conference, and including the first destination number to the conference call based on the first code.

In an embodiment of the present invention, the system for providing pre-paid multi-party conference services includes a system operable to initiate a conference call, receive a first destination number from a first device, receive a first code from the first device specifying whether to include the destination number to the conference, and include the first destination number to the conference call based on the first code.

### BRIEF DESCRIPTION OF THE DRAWINGS

The above described features and advantages of the present invention will be more fully appreciated with reference to the detailed description and appended figures in which:

FIG. 1 depicts an exemplary block diagram of a system of FIG. 1 which can find application according to an embodiment of the present invention;

FIG. 2 depicts an exemplary block diagram of a system of FIG. 1 which can find application according to an embodiment of the present invention;

FIG. 3 depicts an exemplary flow diagram of a method of initiating a pre-paid telephone conference according to an embodiment of the present invention; and

FIG. 4 depicts an exemplary flow diagram of a method of including parties to an established conference call according to an embodiment of the present invention.

### DETAILED DESCRIPTION OF THE INVENTION

The present invention is now described more fully hereinafter with reference to the accompanying drawings that show exemplary embodiments of the present invention. The present invention, however, may be embodied in many different forms and should not be construed as limited to the exemplary embodiments set forth herein. Appropriately, these embodiments are provided so that this disclosure will be thorough, complete, and fully convey the scope of the present invention.

According to embodiments of the present invention, a method, a framework, and a computer program product for providing pre-paid conference calls are provided. The method receives access number data and pin number data. Upon receiving a valid pin number the method establishes a conference call whereby an owner can dynamically add additional parties to the conference call. The method receives a destination number from the owner and determines whether there is a call connection established with a device at the destination number. If there is an answer at the destination number the owner and the party at the destination number are made part of the conference call. If there is no answer at the destination number the owner can enter a reject code that returns the owner to the conference call. This process can be repeated iteratively for a number of destination numbers.

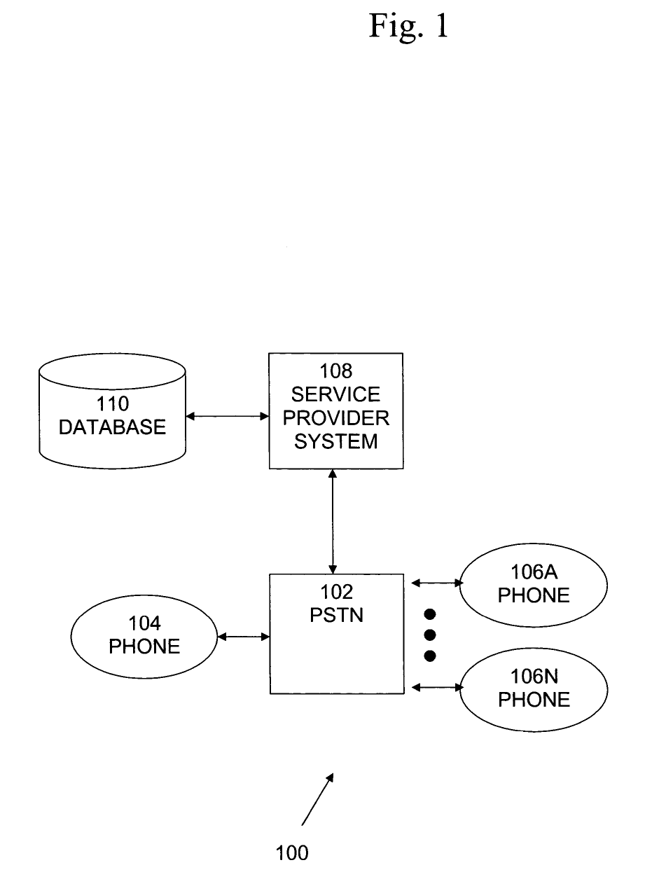

An exemplary block diagram of a system in which the present invention can find application according to an embodiment of the present invention is shown in FIG. 1. In the embodiment of FIG. 1, system 100 may be implemented to perform pre-paid multiparty teleconferencing service between a calling party, such as a conference owner and moderator, and conference participants. In the FIG. 1 embodiment of the present invention, system 100 includes Service Provider System 108, PIN database 110, PSTN 102, device 104 and devices 106A-106N. The system 100 may transmit using the network 102, any combination of voice, video and/or data between device 104 and devices 106 as well as between devices 106.

In the FIG. 1 embodiment of the present invention, the Service Provider system 108 is coupled to PIN database 110 and Public Switch Telephone Network (“PSTN”) 102. There can be a plurality of systems 108 provided at various regional locations, where each regional system 108 is coupled to network 102. The Service Provider System 108 can provide pre-paid telephone services, and pre-paid multi-party teleconferencing services employing PSTN 102 between device 104 and devices 106 as well as between devices 106. The Service Provider System 108 may be any apparatus from which, and to which, any combination of voice video and/or data may be transmitted over a network, such as the Internet, or PSTN 102. The Service Provider System 108 can be provided by a provider of pre-paid telephone and multi-party teleconferencing services.

In the FIG. 1 embodiment of the present invention, PIN database 110 may be any computer that stores PIN numbers as well as structured information managed by applications developed and used by Service Provider System 108, such as PIN numbers, remaining PIN number account values, telephone numbers, and cost per call between locations. The PIN database 10 may directly transfer information to Service Provider System 108 in response to a request from Service Provider System 108. The PIN database may be physically or logically connected to Service Provider System 108.

In the FIG. 1 embodiment of the present invention, PSTN 102 couples to device 104 and devices 106A-106N. The PSTN 102 represents any portion, or the entire, world wide telephone system. The PSTN 102 can receive dialed telephone numbers, such as a pre-paid service provider's access number, and transmit voice and data between device 104 and devices 106A-106N as well as between devices 106A-106N employing Service Provider System 108.

In the FIG. 1 embodiment of the present invention, device 104 and devices 106A-106N are coupled to the PSTN 112 in a normal and conventional fashion. Device 116 and devices 118A-118B include, but are not limited to, a telephone or computer. Device 16 and devices 118A-118B can be equipped with DTMF tones capability. In the FIG. 1 embodiment of the present invention, devices 116 and 118 are coupled to PSTN by communications including, but is not limited to, a telephone line and a wireless network.

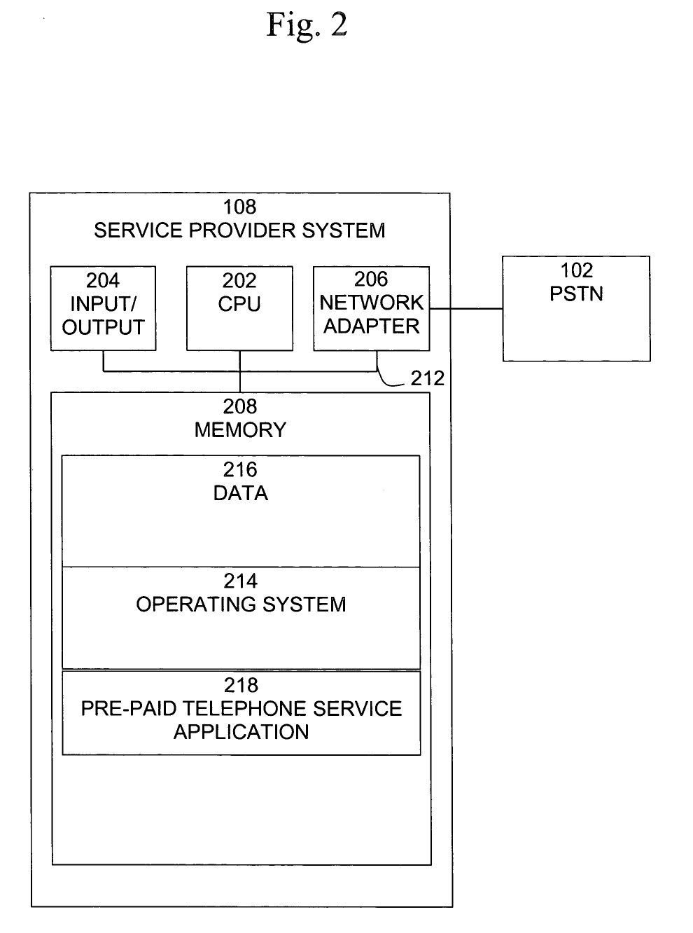

An exemplary block diagram of a systems 108 of FIG. 1 which can find application according to an embodiment of the present invention is shown in FIG. 2. In the FIG. 2 embodiment of the present invention, the Service Provider System 108 includes input/output device interface, and display interface 204 and network adapter 206, system memory 208 and CPU 202. The CPU 202 is connected by a bus 212 or other suitable interface means to system memory 208, input/output device interface, and display interface 204 and network adapter 206. The CPU 202 executes program instructions in order to carry out the functions of the present invention.

Input/output device interface 204 provides the capability to input data to, or output data from system 102. For example, input/output device interface 204 includes, but is not limited to, input devices such as a readers, keyboards, mice, touchpads, trackballs, etc., output devices such as video, monitors, printers, etc., and input/output devices such as dialer/modems, etc. Input/output device interface 204 enables access by, and use of, PSTN 102 employing a PIN number and an access number of a pre-paid telephone service provider through device 104 and devices 106A-106N. Network adapter 206 interfaces system 108 with network 102.

Systems memory 208 stores program instructions that are executed by, and data that are used and processed by, CPU 202 to perform the functions of Service Provider System 108. Systems memory 208 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

In the FIG. 2 embodiment of the present invention, systems memory 208 includes, operating system 214, data 216 and pre-paid telephone service application 218. Operating system 214 provides overall system functionality. The data 216 includes account information for all customers of the pre-paid telephone and teleconferencing services provider. The pre-paid telephone service application 218 provides the functionality for performing multiparty teleconferencing and outdialing, providing voice mail and interactive voice response, activating PIN numbers, managing access to pre-paid telephone services, rate plans, PIN number usage and security.

The call conferencing functionality allows for multiparty calling using an interface, such as touch tone dialing. Activation of a PIN number includes receiving notification that a pre-paid telephone service transaction has occurred, selection of a unique PIN number from PIN database 110, associating a value amount from the pre-paid service transaction with the PIN number. The outdialing functionality allows for initiation of a call to a dialed party upon entry of a valid PIN number. A valid PIN number is one that is active and has a balance that is not zero. The voice mail functionality allows for storage of audio messages in a mailbox. The interactive voice response allows for audio messages to guide user's in using the system. The management functionality allows for verification that a PIN number is valid and has a remaining balance, determining the monetary value of a transaction, and deduction of PIN number balance.

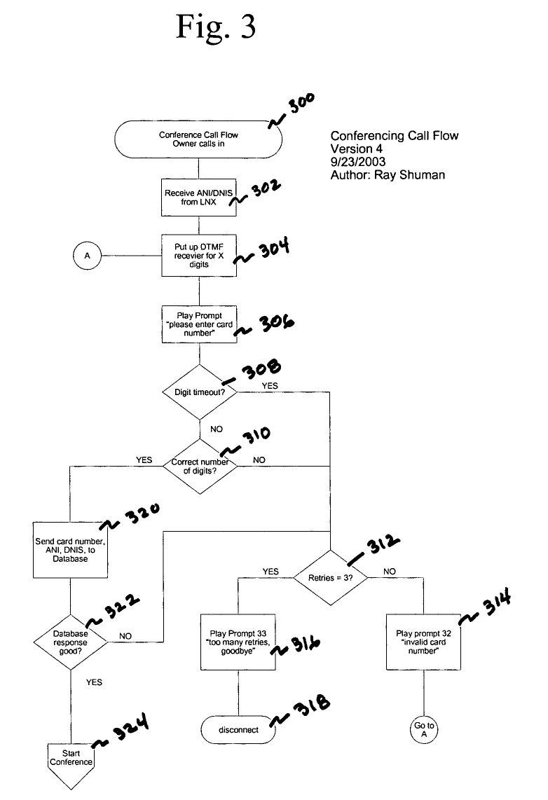

An exemplary flow diagram for a method of initiating a pre-paid telephone conference according to an embodiment of the present invention is shown in FIG. 3. In the FIG. 3 embodiment, the process begins with step 300. At step 300, a multi-party conference call is initiated. A multi-party conference call is initiated when the calling party, the owner of the conference call, dials an access number which connects him directly to system 108 via the PSTN 102. At step 302, the system 108 receives an inbound call indication that a calling party has initiated a telephone call and instructs the software 218 to answer the call. The software receives information from the PSTN 102. Specifically, the PSTN provides Service Provider System 108 with Automatic Number Identification (ANI) digits identifying the calling party as well as Dialed Number Identification (DNIS) digits.

At step 304, a DTMF receiver is put up. At step 306, the calling party is prompted to provide their pre-paid PIN number. The PIN number can be obtained by purchasing a dollar amount of pre-paid services from a pre-paid telephone service provider including, but not limited to, depositing the dollar value into an account set up for purchasing pre-paid services from the pre-paid telephone service provider, and providing the dollar value to a merchant partnered with the pre-paid telephone service provider to receive funds for pre-paid telephone service. The PIN number enables the purchase to receive pre-paid telephone service from the pre-paid telephone service provider in the dollar amount purchased.

At step 308, it is determined whether a timeout period for the owner to enter the pre-paid PIN number has expired. If the timeout period has not expired, the process proceeds to step 310. At step 310, it is determined whether the correct number of digits has been entered for the PIN number. If the correct number of digits for the PIN number has not been entered the process proceed to step 312.

At step 312, it is determined whether the owner has exceed an allotted number of attempts by system 108. In the FIG. 3 embodiment of the present invention, the system 108 allots three attempts for the proper entry of the owner's PIN number. If the owner has not exceed the allotted number of attempts, the process proceeds to step 314.

At step 314, the owner is prompted that the PIN number entered is invalid and, the process returns to step 304. If the owner has exceeded the allotted number of attempts, the process proceeds to step 316. At step 316, the owner is prompted that he has exceed the allotted number of attempts. At step 318, the owner is disconnected. If the owner has entered the correct number of digits, the process proceeds to step 320.

At step 320, DNIS, ANI and the PIN number entered are provided to a database, such as PIN database 110. At step 322, it is determined whether the PIN number entered is validated. Validating the PIN number can include, but is not limited to, determining whether the PIN number entered corresponds with a PIN number in the pin database 10, determining whether the PIN number is flagged as active, and determining whether there are sufficient funds associated with the PIN number to receive a pre-paid service offered by the pre-paid telephone service provider. A validated PIN number allows the calling party access to the pre-paid services offered by the pre-paid telephone service provider. If the PIN number is not valid, the process proceeds to step 312. If the PIN number is valid, the process proceeds to step 324. At step 324, call conferencing capabilities are established for owner to dynamically add parties to the conference call.

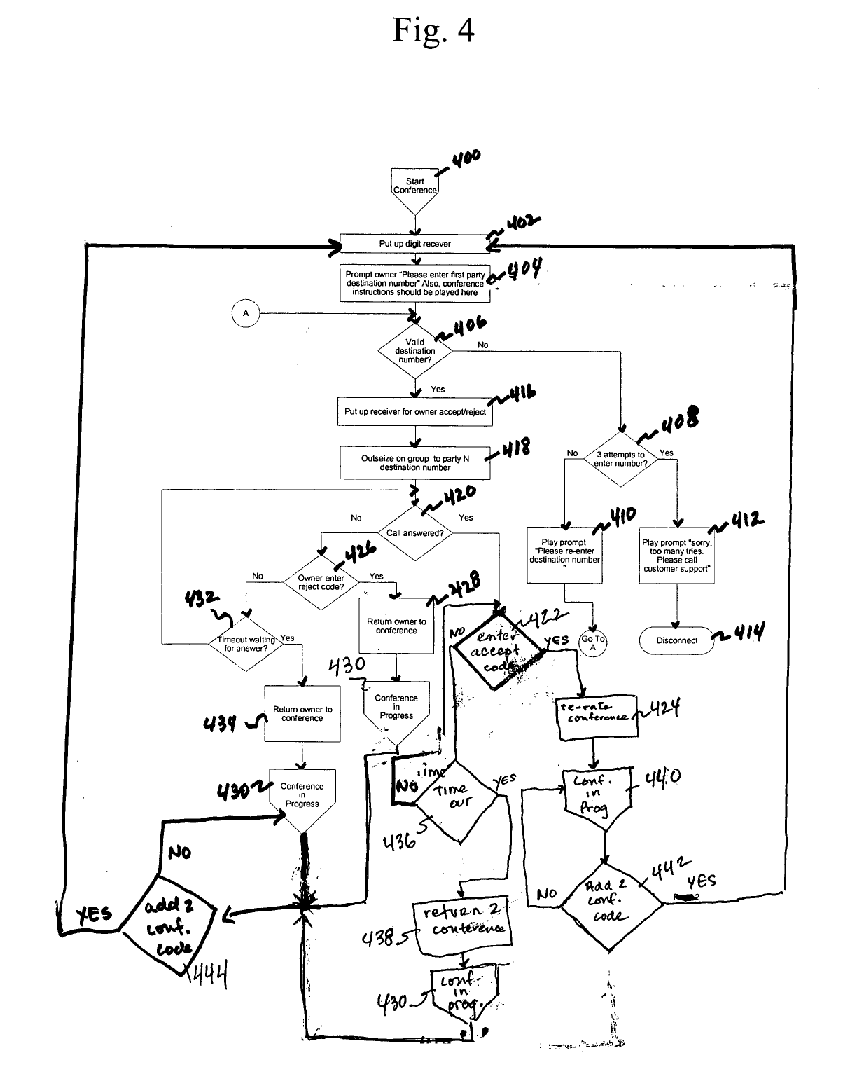

An exemplary flow diagram for a method of including conference parties to an initiated conference call according to an embodiment of the present invention is shown in FIG. 4. In the FIG. 4 embodiment, the process begins with step 402. In step 402, a digit receiver is put up. This includes, but is not limited to, enabling a switch to accept DTMF tones.

At step 404, the calling party is prompted to enter a potential conferencee's destination telephone number. This can include providing instructions to direct the calling party, such as moderator or owner, on how to correctly provide the conferencee's destination telephone number.

At step 406, it is determined whether the destination telephone number is a valid destination number. If the destination number is not a valid the process proceeds to step 408.

At step 408, it is determined whether three attempts at entering a destination number has been performed. If three attempts to enter the destination number has not been performed the process proceeds to step 410. At step 410, the calling party is prompted to re-enter the destination number and, the process returns to step 406. If three attempts to enter the destination number has been performed the process proceeds to step 412. At step 412, the calling party is prompted to contact customer service The process proceeds to step 414. At step 414, the calling party is disconnected from the system 108. If the destination number is valid the process proceeds to step 416.

At step 416, a receiver is put up for accept code and reject code. This includes, but is not limited to, enabling a switch to accept DTMF tones corresponding to accept codes and reject codes. At step 418, one group is outsized to the destination number of the called party. This includes, but is not limited to, establishing a call connection to the destination number. At step 420, it is determined whether the called party answers at the destination number answers. If there is no answer at the destination number the process proceeds to step 426. If there is an answer the process proceeds to step 422.

At step 426, it is determined whether the calling party entered a reject code. The reject code includes, but is not limited to, a set of digits, a set of symbols and a combination thereof, on the calling party's device, such as device 104 or 106. Entry of the reject code generates DTMF tones corresponding to the code. These DTMF tones are received and recognized by system 108. If the reject code is entered, the process proceeds to step 428.

At step 428, the calling party returns to the conference in progress. The process then proceeds to step 430. At step 430, the calling party is in the conference in progress. At step 444, it is determined whether the calling party, such as owner, entered an add to conference code. The add to conference code includes but is not limited to, a set of digits, a set of symbols and a combination thereof, on the calling party's device, such as device 104 or 106. Entry of the add to conference code generates DTMF tones corresponding to the code. These DTMF tones are received and recognized by system 108. In response to the DTMF tones, system 108 returns to step 402. If there is no entry of add to conference code the process returns to step 430. If there is no entry of a reject code the process proceeds to step 432.

At step 432, it is determined whether a timeout period has elapsed. The timeout period provides the calling party with a period of time in which to enter the reject code. If the timeout period has not elapsed, the process returns to step 420. If the timeout period has elapsed, the process proceeds to step 434.

At step 434, the calling party returns to the conference in progress. The process then proceeds to step 430. At step 430, the calling party is in the conference in progress. At step 444, it is determined whether the calling party, such as owner, entered an add to conference code. The add to conference code includes but is not limited to, a set of digits, a set of symbols and a combination thereof, on the calling party's device, such as device 104 or 106. Entry of the add to conference code generates DTMF tones corresponding to the code. These DTMF tones are received and recognized by system 108. In response to the DTMF tones, system 108 returns to step 402. If there is no entry of add to conference code the process returns to step 430.

At step 422, it is determined whether the calling party entered an accept code. The accept code includes, but is not limited to, a set of digits, a set of symbols and a combination thereof, on the calling party's device, such as device 104 or 106. Entry of the accept code generates DTMF tones corresponding to the code. These DTMF tones are received and recognized by system 108. In response to the DTMF tones, system 108 performs specific functions represented by the DTMF tones in step 424. If there is no entry of an accept code the process proceeds to step 436.

At step 436, it is determined whether a timeout period has elapsed. The timeout period provides the calling party with a period of time in which to enter the accept code. If the timeout period has not elapsed, the process remains at step 422. If the timeout period has elapsed, the process proceeds to step 438.

At step 438, the calling party returns to the conference in progress. The process the proceeds to step 430. At step 430, the calling party is in a conference in progress. At step 444, it is determined whether the calling party, such as owner, entered an add to conference code. The add to conference code includes but is not limited to, a set of digits, a set of symbols and a combination thereof, on the calling party's device, such as device 104 or 106. Entry of the add to conference code generates DTMF tones corresponding to the code. These DTMF tones are received and recognized by system 108. In response to the DTMF tones, system 108 returns to step 402. If there is no entry of add to conference code the process returns to step 430. If the accept code is entered, the process proceeds to step 424.

At step 424, the cost of the conference call is re-rated. This includes taking into consideration the cost for the additional leg of telephone service that includes the destination number. At step 440, the called party at the destination number is included in the conference in progress.

At step 442, it is determined whether the calling party, such as owner, entered an add to conference code. The add to conference code includes but is not limited to, a set of digits, a set of symbols and a combination thereof, on the calling party's device, such as device 104 or 106. Entry of the add to conference code generates DTMF tones corresponding to the code. These DTMF tones are received and recognized by system 108. In response to the DTMF tones, system 108 returns to step 402. If there is no entry of add to conference code the process returns to step 440.

While specific embodiments of the present invention have been illustrated and described, it will be understood by those having ordinary skill in the art that changes can be made to those embodiments without departing from the spirit and scope of the invention.

1. A method of providing pre-paid multi-party conference services, the method comprising the steps of:
initiating a conference call;
receiving a first destination number from a first device;
receiving a first code from the first device specifying whether to include the destination number to the conference; and
including the first destination number to the conference call based on the first code.

2. The method according to claim 1, wherein the first code is a reject code specifying the exclusion of the first destination number to the conference call.

3. The method according to claim 1, wherein the first code is an accept code specifying the inclusion of the first destination number to the conference call.

4. The method according to claim 1, further comprising providing a prompt requesting the first destination number.

5. The method according to claim 1, further comprising receiving a second code from the first device specifying whether to initiate the addition of another destination number to the conference call.

6. The method according to claim 4, further comprising receiving the other destination number from the first device.

7. The method according to claim 6, further comprising receiving the first code from the first device specifying whether to include the other destination number to the conference.

8. The method according to claim 7, further comprising including the other destination number to the conference call based on the first code.

9. A system for providing pre-paid multi-party conference services comprising::
A first system operable to:
initiate a conference call;
receive a first destination number from a first device;
receive a first code from the first device specifying whether to include the destination number to the conference; and
include the first destination number to the conference call based on the first code.

10. The system according to claim 9, wherein the first code is a reject code specifying the exclusion of the first destination number to the conference call.

11. The system according to claim 9, wherein the first code is an accept code specifying the inclusion of the first destination number to the conference call.

12. The system according to claim 9, further comprising the system operable to provide a prompt requesting the first destination number.

13. The system according to claim 1, further comprising the system operable to receive a second code from the first device specifying whether to initiate the addition of another destination number to the conference call.

14. The system according to claim 13, further comprising the system operable to receive the other destination number from the first device.

15. The system according to claim 14, further comprising the system operable to receive the first code from the first device specifying whether to include the other destination number to the conference.

16. The system according to claim 15, further comprising the system operable to include the other destination number to the conference call based on the first code.

17. The system according to claim 1, further comprising a network, coupled to the system, operable to transmit voice and data communication.

18. The system according to claim 1, wherein the network is a PSTN.

19. The system according to claim 1, further comprising at least two devices, coupled to the PSTN, operable to provide voice and data.
